(19) United States
(12) Patent Application Publication
(10) Pub. No.: US 2004/0228298 A1
(43) Pub. Date: Nov. 18, 2004

(54) Packet communication service method

(76) Inventor: Young Jo Lee, Seoul (KR)

Correspondence Address: FLESHNER & KIM, LLP, P.O. BOX 221200, CHANTILLY, VA, 20153, US

(21) Appl. No.: 10/832,481

(22) Filed: Apr. 27, 2004

(30) Foreign Application Priority Data
Apr. 28, 2003 (KR) P2003-26729

(51) Int. Cl. H04K 1/00

(52) U.S. Cl. 370/328; 370/352

(57) ABSTRACT

A packet communication service method enhances quality of service for a user of a low-data-rate data communication or voice communication in a packet communication system supporting both high-data-rate and low-data-rate data and voice communications, by reducing mobile-to-mobile interference. When a high-data-rate data user's packet communication is requested within a sector (service area) servicing low-data-rate data users and/or voice users and packets at high data rate are scheduled, a target E_{b}/Nₜ value for transmit power control is incremented by a predetermined offset, so that the low-data-rate data and voice users may be notified of the high-data-rate transmission and may be prepared in advance of the transmission.

### CROSS-REFERENCE TO RELATED APPLICATIONS

This application claims the benefit of Korean Application No. 10-2003-0026729 filed on Apr. 28, 2003, which is hereby incorporated by reference.

### BACKGROUND OF THE INVENTION

1. Field of the Invention

The present invention relates to packet data communications, and more particularly, to a packet communication service method for simultaneously supporting disparate (high and low) data rates for data communications and voice communications, respectively, in which a predetermined offset is applied to the E_{b}/Nₜ value of low-data-rate and voice users in the event of scheduling a high-data-rate packet in the same service area.

2. Discussion of the Related Art

A general mobile communication system provides services to a plurality of users simultaneously operating in the same sector but transmitting at disparate rates. For example, in addition to traditional voice service, which requires only low-data-rate transmission, a first-evolution, data-optimized (1xEV-DO) system provides for high-data-rate transmission. To avoid mobile-to-mobile interference, the voice communications and high-data-rate packet communications are carried out using different frequency assignments, which is practical for low-density areas, i.e., cells having relatively few active users.

Meanwhile, a first-evolution, data-and-voice (1xEV-DV) system enables simultaneous service to a user using the low data rate of voice communication and a user using the high data rate of data communication, so that such users may coexist in the same sector while operating on the same frequency. In this system, a call utilizing a voice communication service remains connected for the duration of the call by way of a circuit-switched (CS) network in which only a maintained call connection enables the transmission of voice frames. In the case of data communication, data packets are transmitted at a high data rate whenever there is data to be transmitted, using a packet-switched (PS) network.

The coexistence of voice communication and data communication, however, brings about the potential for mobile-to-mobile interference, and as a rule, it is the low-data-rate user that is adversely affected. That is, since the total transmission energy resulting from transmission at a high data rate is greater than that produced by low-data-rate (voice) communication, when a mobile station transmitting at a high data rate is introduced to a service area, the low-data-rate user experiences interference due to the higher energy levels produced by the high-data-rate transmissions. Thus, the scheduling of transmissions of high-data-rate packets within a given service area increases the probability of transmission errors for low-data-rate users and degrades their quality of service (speech) accordingly.

Transmit power control (TPC) schemes may be employed in an attempt to overcome the above mobile-to-mobile interference. In controlling the transmit power of a mobile station, its power is repeatedly and continuously incremented or decremented to cope with environmental fluctuations, which ordinarily are gradual changes requiring only slight adjustments. On the other hand, when a high-data-rate user newly accesses a sector (service area) servicing any number of low-data-rate users and requests packet transmission, a base station responsible for the sector will likely permit the scheduling of a data transmission at the high data rate. Thus, the introduction of a high-data-rate mobile station is a sudden change to the environment, which calls for an immediate and perhaps sizeable change in transmit power. Conventional TPC schemes react too slowly and are therefore insufficient for dealing with the mobile-to-mobile interference experienced in providing packet communication services, such that the speech quality of a low-data-rate (voice) user suffers due to an increase in the frame error rate.

### SUMMARY OF THE INVENTION

Accordingly, the present invention is directed to a packet communication service method that substantially obviates one or more of the problems due to limitations and disadvantages of the related art.

An object of the present invention, which has been devised to solve the foregoing problem, lies in providing a method of providing a packet communication service for data and voice communications, such as a 1xEV-DV system, by which, when a high-data-rate user requests packet communication within a sector (service area) servicing low-data-rate and/or voice users, such that packets at a high data rate are scheduled, the low-data-rate and/or voice users are respectively operated in accordance with a target E_{b}/Nₜ value, by applying a predetermined offset to the E_{b}/Nₜ value of the low-data-rate and voice users, to increase accordingly their transmit power before the high-data-rate user transmits, thereby maintaining an acceptable frame error rate.

It is another object of the present invention to provide a packet communication service method, which enhances the quality of service to low-data-rate and voice users in a packet communication system simultaneously serving a high-data-rate user.

It is another object of the present invention to provide a packet communication service method, which reduces mobile-to-mobile interference.

Additional features and advantages of the invention will be set forth in the description which follows, and in part will be apparent to those having ordinary skill in the art upon examination of the following or may be learned from a practice of the invention. The objectives and other advantages of the invention will be realized and attained by the subject matter particularly pointed out in the specification and claims hereof as well as in the appended drawings.

To achieve these objects and other advantages in accordance with the present invention, as embodied and broadly described herein, there is provided a method of providing a packet communication service in a sector of a system scheduling a high-data-rate packet transmission while serving a low-data-rate user employing outer loop power control to determine a first set point of an E_{b}/Nₜ value for controlling transmit power on a traffic channel. The method comprises steps of controlling, prior to a transmission of the high-data-rate packets, the transmit power of the traffic channel based on a second set point, the second set point being equal to the first set point plus a predetermined offset; and controlling, after completion of the transmission of the high-data-rate packets, the transmit power of the traffic channel based on a third set point, the third set point being determined without application of the predetermined offset.

The above method of the present invention may be exercised in the reverse link by a mobile station or may be exercised in the forward link by a base station.

For the reverse link, there is provided a packet communication service method comprising steps of scheduling a high-data-rate packet having a predetermined transmission power; respectively applying, prior to transmission of the scheduled high-data-rate packet, a predetermined offset to an E_{b}/Nₜ set point of an outer loop power control for at least two mobile stations located within a sector; and allocating transmission power of the at least two mobile stations to correspond to the transmission power of the high-data-rate packet until a transmission end time of the high-data-rate packet.

For the forward link, there is provided a packet communication service method comprising steps of scheduling a high-data-rate packet having a predetermined transmission power; notifying, prior to transmission of the high-data-rate packet, at least two mobile stations located within a sector of information on the transmission of the high-data-rate packet; respectively setting, based on the information of said notifying step, an E_{b}/Nₜ set point of an outer loop power control for the at least two mobile stations to correspond to an E_{b}/Nₜ value of the high-data-rate packet; and allocating transmission power for the at least two mobile stations according to the respectively set E_{b}/Nₜ set points.

It is to be understood that both the foregoing explanation and the following detailed description of the present invention are exemplary and illustrative and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a graph of the E_{b}/Nₜ values of a mobile station performing an exemplary low-data-rate or voice communication (call) in accordance with a related art method, illustrating the potential for mobile-to-mobile interference when high-data-rate packets are scheduled in a sector servicing the low-data-rate or voice user;

FIG. 2 is a flowchart of a packet communication service method according to the present invention; and

FIG. 3 is a graph of the E_{b}/Nₜ values of a mobile station performing an exemplary low-data-rate or voice communication (call) in accordance with the method of the present invention, in which high-data-rate packets are scheduled in a sector servicing the low-data-rate or voice user.

### DETAILED DESCRIPTION OF THE PREFERRED EMBODIMENT

Reference will now be made in detail to the preferred embodiment of the present invention, examples of which are illustrated in the accompanying drawings. Throughout the drawings, like elements are indicated using the same or similar reference designations.

In the following description, references to the transmission of packet data at a low data rate are meant to encompass data transmission at a rate appropriate for voice communication. Thus, “low data rate” transmission is to be understood as being inclusive of such transmission (including low-data-rate data) for voice communication, e.g., by voice frames.

The present invention is based on a packet communication service using the 1xEV-DV system, in which voice information (low-data-rate data) transferred in the packet communication service is transmitted by frame units within a physical environment and data is transmitted by packet units. The 1xEV-DV system adopting the present invention assigns one frequency for both voice and data communications but provides separate channels, e.g., using Walsh codes, for transmitting voice and data over the same frequency.

The present invention is appropriate for, but not limited to, a 1xEV-DV system and may be applied to any communication system in which both high-data-rate and low-data-rate users co-exist within a service area. Here, a low data rate is a rate of up to several tens of kilobytes per second, such as 9.6 kbps, 14.4 kbps, or 14.4×Nkbps (where N is an integer greater than one), while a high data rate is a rate of up to about 2 Mbps. Thus, mobile-to-mobile interference may occur when there is a marked difference in transmission rates (or transmission powers) between various users co-existing within the same service area.

In providing a packet communication service, packet data is transmitted at a predetermined rate on a traffic channel, and the total transmission power varies according to the data rate. Thus, the transmit power of the traffic channel is controlled. Here, the transmit power control of a traffic channel employs both outer-loop and inner-loop power control schemes, each of which are based on a ratio of the energy-per-bit (E_{b}) to the spectral noise density (Nₜ), i.e., an E_{b}/Nₜ value or “set point,” of the traffic channel as measured at the receiver. In outer loop power control, an E_{b}/Nₜ value is set based on a target frame error rate for a given transmission rate of the traffic channel. In inner loop power control, the transmit power of the traffic channel is adjusted (set) based on a comparison of the E_{b}/Nₜ set point, i.e., the value determined by the outer loop power control and measured in decibels, and the E_{b}/Nₜ value of the received traffic channel.

For example, a mobile station provides outer loop power control for its allocated forward traffic channels, which include a forward dedicated control channel, a forward fundamental channel, and a forward supplemental channel. Thus, the mobile station sets the E_{b}/Nₜ set point to attain a target frame error rate for a transmission rate of a forward channel being monitored. The mobile station then refers to the E_{b}/Nₜ set point to implement the inner loop power control for the received forward dedicated control channel, forward fundamental channel, or forward supplemental channel. In doing so, the mobile station compares a corresponding E_{b}/Nₜ set point of the outer loop power control to the E_{b}/Nₜ value of the received forward traffic channel and adjusts (increments or decrements) its transmit power based on the comparison.

The present invention is applied when scheduling high-data-rate packets. In doing so, the present invention is characterized in that a mobile station is notified (informed in the preceding voice frame) of the E_{b}/Nₜ value required to attain the target frame error rate, the required E_{b}/Nₜ value being one raised by a predetermined offset based on the outer loop power control. The mobile station increments the set point of the outer loop power control by an amount equal to the offset and then, before transmission of the high-data-rate packets, begins transmitting at the incremented power level, which is an appropriate level for coping with the transmission of the high-data-rate packets.

Accordingly, parameters used in the present invention for the outer loop power control include target frame error rate, minimum E_{b}/Nₜ set point, and maximum E_{b}/Nₜ set point, and the offset value is used for incrementing the maximum E_{b}/Nₜ set point.

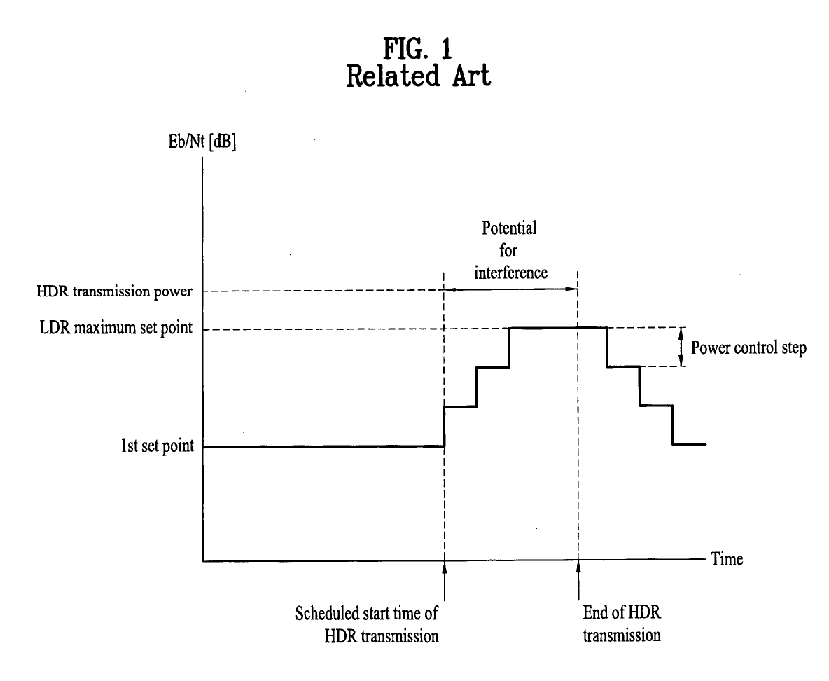

To illustrate the potential for mobile-to-mobile interference when high-data-rate packets are scheduled in a sector servicing a low-data-rate user, the E_{b}/Nₜ values of a low-data-rate call made in accordance with a related art method are shown in FIG. 1.

Referring to FIG. 1, a low-data-rate (LDR) communication is carried out at a low data rate, a high-data-rate (HDR) communication is scheduled such that high-data-rate packets are transmitted to interfere with the voice communication currently in traffic, and the low-data-rate mobile station increments a set point (i.e., its first set point) of an outer loop power control, thereby ramping its transmit power. Adjustment of the set point of the outer loop power control begins from the scheduled time of transmitting the high-data-rate packet, and a maximum set point of the outer loop power control falls below the E_{b}/Nₜ value of the high-data-rate packets. Hence, the outer loop power control is unable to react in time to prevent interference due to the transmission of the high-data-rate packet, such that the quality of service of the mobile station transmitting/receiving low-data-rate (voice) data is degraded. An attempt to solve this problem may include simply operating the voice/LDR communication mobile station at a power level equivalent to that of high-data-rate packet, but doing so would greatly increase its power consumption. Further, if all such mobile stations were to transmit accordingly, the transmission environment would become unnecessarily saturated. Therefore, according to the present invention, when high-data-rate packets are scheduled by request of any one mobile station, a voice/LDR communication mobile station is notified of the transmission of high-data-rate packets.

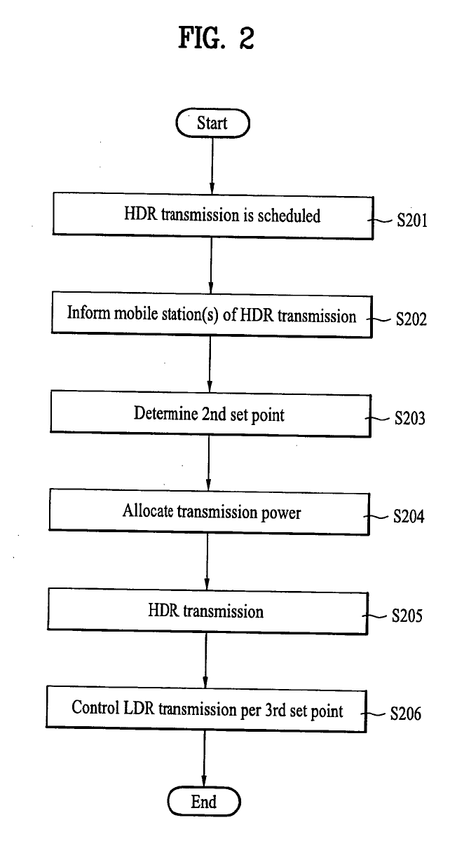

FIG. 2 illustrates a packet communication service method according to the present invention. Here, it is assumed that a high-data-rate user requests packet communication service in a given sector and that at least one mobile station is operating in the same sector at a low data rate. In a step S201, the high-data-rate (HDR) packet transmission is scheduled. At this time, the low-data-rate (LDR) mobile station is unaware of such transmission.

Accordingly, in a step S202, the low-data-rate packet mobile station is informed, i.e., notified in advance by the base station, of the scheduled time of transmission of the high-data-rate packets and other information, particularly including channel assignment. The voice frame immediately preceding the start of the high-data-rate transmission is used for transmitting the information to the mobile station(s), and any combination of a variety of techniques may be used. For example, the base station may inform all the mobile stations within a sector of the frequency assignment to be used for a specific transmission of high-data-rate packets; the base station may inform all the mobile stations within a sector of a packet channel via which high-data-rate packets could be transmitted or of a control channel of a packet channel via which high-data-rate packets are to be transmitted; and/or the base station may use a common channel to inform all the mobile stations within a sector of a scheduled start time for transmitting high-data-rate packets, whereby a voice channel is used to inform voice communication mobile stations and a packet channel is used to inform low-data-rate packet mobile stations. By being thus informed, the mobile stations may monitor the appropriate packet channel(s) and/or control channel(s) thereof, to determine the actual start of high-data-rate transmission and, importantly, the end of such transmission. In addition to the time of high-data-rate packet transmission, the information from the base station may include an advance indication, using one bit or more, of whether high-data-rate packets will be transmitted, e.g., an indication of a “transmission-on” or “transmission-off” state of the high-data-rate packets, and may further include such information as transmission speed of the high-data-rate packet, transmission power, and or other information sufficient for the mobile station to set a maximum set point corresponding to the E_{b}/Nₜ of the high-data-rate packets.

In a step S203, prior to a scheduled transmission of high-data-rate packets, an outer loop power control for a low-data-rate mobile station is executed to determine a maximum set point, i.e., a second set point, to which a predetermined offset is added for coping with the high-data-rate packet transmission. Here, the maximum set point is set for each low-data-rate mobile station, and the value of the added offset is based on the E_{b}/Nₜ value of the high-data-rate packet transmission. Hence, before the scheduled transmission of high-data-rate packets, the transmit power levels of the low-data-rate mobile stations are respectively increased.

That is, in a step S204, transmit power is allocated to voice communication mobile stations (and to other low-data-rate packet mobile stations) in preparation for coping with the higher transmission levels of the high-data-rate packets. In doing so, the value of each offset is determined—and thus transmit power is allocated—using parameters of current transmit power, the status of allocated channel(s), the transmission speed of the high-data-rate packets, locations of the low-data-rate mobile stations, and the respective transmission speeds of the low-data-rate packets and/or voice communication. In the above transmission power allocation, an offset is determined for each low-data-rate mobile station according to the above parameters, or the same offset may be determined for a mobile station group communicating at the same transmission speed. In a simplified approach, a single offset value may be determined for all the low-data-rate mobile stations within a sector, to cope with the transmission power of a predetermined high-data-rate packet, whereby one offset value is calculated for the mobile station having the lowest maximum set point among the low-data-rate packet and voice communication mobile stations. It should be appreciated that, besides these methods for determining additional offsets and allocating transmission power, other methods may be employed.

With the offsets thus determined, the high-data-rate packet transmission proceeds to completion in a step S205. Upon terminating the transmission, the added offset is removed from the maximum set point, i.e., negated, so that normal TPC operations may resume based on a third set point. That is, in a step S206, the original power control of the low-data-rate packet and voice communication mobile stations is restored.

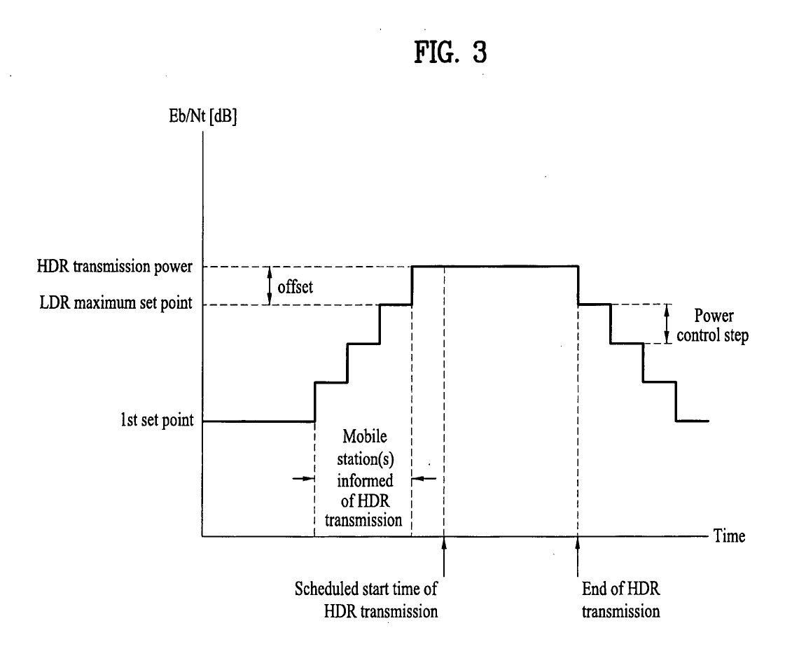

FIG. 3, which is a graph similar to that of FIG. 1 and shows the E_{b}/Nₜ values of a mobile station performing an exemplary low-data-rate or voice communication (call), demonstrates the results of adopting the packet transmission service method of the present invention. Here, when a voice communication is carried out at low data rate, i.e., a call connects a voice communication mobile station to a base station responsible for one sector, if a communication of high-data-rate packets is requested, a predetermined offset is applied to a maximum set point determined for the voice communication mobile station—specifically, the offset is added to the maximum set point. The value of the applied offset corresponds to the E_{b}/Nₜ value of the high-data-rate packets, whereby the voice communication mobile station raises its transmit power to cope with the transmission power of the high-data-rate packets. Communication proceeds thusly until the transmission of the high-data-rate packets is terminated.

Consequently, since the set point of the outer loop power control is increased by the offset one frame before the transmission of the high-data-rate packets, a new maximum set point (previous maximum set point+offset) of the outer loop power control corresponds to the E_{b}/Nₜ value of the high-data-rate packets. Hence, interference due to the transmission of the high-data-rate packets can be prevented, and the quality of service (speech quality) of the voice communication mobile station is preserved accordingly.

According to the present invention, even if high-data-rate packets are scheduled as a packet transmission of a high-data-rate data user within the sector servicing a low-data-rate data user or voice communication user, the low-data-rate (& voice) mobile stations are notified (informed in advance) so that the target E_{b}/Nₜ value for the low-data-rate users may be increased by a predetermined offset, to increase their transmit power accordingly, thereby reducing the mobile-to-mobile interference due to the presence of the high-data-rate packet transmission. Reduction of mobile-to-mobile interference enables an enhancement of the speech quality of low-data-rate users when high-data-rate packets are scheduled in the same sector.

It will be apparent to those skilled in the art that various modifications and variations can be made in the present invention without departing from the spirit or scope of the invention. Thus, it is intended that the present invention embody such modifications and variations, provided they come within the scope of the appended claims and their equivalents.

What is claimed is:

1. A method of providing a packet communication service in a sector of a system scheduling a high-data-rate packet transmission while serving a low-data-rate user employing outer loop power control to determine a first set point of an E_{b}/Nₜ value for controlling transmit power on a traffic channel, the method comprising a step of controlling, prior to a transmission of the high-data-rate packets, the transmit power of the traffic channel based on a second set point, the second set point being equal to the first set point plus a predetermined offset.

2. The method as claimed in claim 1, further comprising a step of controlling, after completion of the transmission of the high-data-rate packets, the transmit power of the traffic channel based on a third set point, the third set point being determined without application of the predetermined offset.

3. The method as claimed in claim 1, wherein the transmit power of the traffic channel is controlled for the duration of the transmission of the high-data-rate packets.

4. The method as claimed in claim 1, wherein, during the transmission of the high-data-rate packets, the second set point is used to carry out an outer loop power control of the traffic channel.

5. The method as claimed in claim 1, wherein the second set point is used to carry out an inner loop power control of the traffic channel.

6. The method as claimed of claim 1, wherein the second set point attains a target frame error rate for the traffic channel.

7. A packet communication service method comprising steps of:
scheduling a high-data-rate packet having a predetermined transmission power;
respectively applying, prior to transmission of the scheduled high-data-rate packet, a predetermined offset to an E_{b}/Nₜ set point of an outer loop power control for at least two mobile stations located within a sector; and
allocating transmission power of the at least two mobile stations to correspond to the transmission power of the high-data-rate packet until a transmission end time of the high-data-rate packet.

8. The packet communication service method of claim 7, wherein the offset is determined using at least one of transmission speed, mobile station location, transmission power, and allocated channel status.

9. The packet communication service method of claim 8, wherein the offset is is commonly allocated to mobile stations having an equal transmission speed.

10. The packet communication service method of claim 7, wherein the at least two mobile stations are a low-data-rate packet communicating mobile station and a voice communicating mobile station.

11. The packet communication service method of claim 10, wherein the offset allocated to the low-data-rate packet communicating mobile station is different from the offset allocated to the voice communicating mobile station.

12. The packet communication service method of claim 7, further comprising steps of:
calculating the offset so that the transmit power of the mobile station having a lowest maximum E_{b}/Nₜ set point among the at least two mobile stations corresponds to the transmission power of the high-data-rate packet; and
applying the calculated offset to the E_{b}/Nₜ set point of the at least two mobile stations.

13. The packet communication service method of claim 7, further comprising a step of notifying the at least two mobile stations of a transmission start time of the high-data-rate packet and the transmission end time of the high-data-rate packet.

14. The packet communication service method of claim 13, wherein the mobile station applies the offset to the E_{b}/Nₜ set point of the outer loop power control prior to the transmission start time and negates the offset after the transmission end time.

15. The packet communication service method of claim 14, wherein, prior to the transmission start time, the mobile station carries out an inner loop power control based on the E_{b}/Nₜ set point having the offset applied.

16. The packet communication service method of claim 14, wherein, after the transmission end time, the mobile station carries out an inner loop power control based on the E_{b}/Nₜ set point having the offset negated.

17. A packet communication service method comprising steps of:
scheduling a high-data-rate packet having a predetermined transmission power;
notifying, prior to transmission of the high-data-rate packet, at least two mobile stations located within a sector of information on the transmission of the high-data-rate packet;
respectively setting, based on the information of said notifying step, an E_{b}/Nₜ set point of an outer loop power control for the at least two mobile stations to correspond to an E_{b}/Nₜ value of the high-data-rate packet; and
allocating transmission power for the at least two mobile stations according to the respectively set E_{b}/Nₜ set points.

18. The packet communication service method of claim 17, wherein, prior to the transmission of the high-data-rate packet, the at least two mobile stations are notified of one of a transmission time of the high-data-rate packet, a frequency for the transmission of the high-data-rate packet, a packet channel for the transmission of the high-data-rate packet, a control channel of the packet channel, a transmission speed of the high-data-rate packet, and the transmission power of the high-data-rate packet.

19. The packet communication service method of claim 17, wherein the information of said notifying step is transmitted via a voice channel allocated to a voice communication mobile station.

20. The packet communication service method of claim 17, wherein the information of said notifying step is transmitted via a packet channel allocated to a low-data-rate packet mobile station.

21. The packet communication service method of claim 17, wherein the information of said notifying step is transmitted to the at least two mobile stations, during a one frame period immediately preceding the transmission of the high-data-rate packet.
